(19) United States
(12) Patent Application Publication
(10) Pub. No.: US 2008/0134464 A1
(43) Pub. Date: Jun. 12, 2008

(54) Device for Opening and Retaining Rotating Leaf Doors

(75) Inventor: Luciano Salice, Carimate (IT)

Correspondence Address: COLLARD & ROE, P.C., 1077 NORTHERN BOULEVARD, ROSLYN, NY, 11576, US

(73) Assignee: ARTURO NSALICE S.P.A.

(21) Appl. No.: 11/793,257

(22) PCT Filed: Oct. 16, 2006
(86) PCT No.: PCT/EP2006/067447

§ 371 Date: Jun. 18, 2007

(30) Foreign Application Priority Data
Oct. 18, 2005 (IT) RM2005U000126

(51) Int. Cl. E05F 5/10

(52) U.S. Cl. 16/84

(57) ABSTRACT

Device for opening and retaining leaf doors, hinged to the covering walls of a piece of furniture, to shut the door gently. This rod device is extremely compact as compared to other known devices. It is also economical and reliable, ensuring correct working over time, without inappropriate backlash. Advantageously, the device of the invention is particularly functional also when adjustments are made to the door with respect to the piece of furniture body.

### FIELD OF THE INVENTION

This invention refers to a device for opening and retaining leaf doors of pieces of furniture, particularly suitable for installation also in pieces of furniture that are not very deep.

### BACKGROUND ART

Several opening and retaining devices for rotating and turn/tilt doors of pieces of furniture are known. One device is described in document EP0794309. This device consists of a lever connected to the furniture body, preferably to the covering wall, the free end of which slides on a rail on the inner face of the door. The lever is activated by an elastic device, such as a gas spring. The leaf consists of two folding doors, where the movement of the lower door towards the upper door is guided by at least one slide in a vertical guide fixed to the side wall of the piece of furniture. The same device can also be used for leaves with a single door, where the slide and side guide make it superfluous.

Another example of an opening device for single-leaf doors is described in document DE-U 7705285. This opening device is fixed to the side of the piece of furniture, and in this case too, there is a slide for the free end of the lever.

Devices like those described above have some disadvantages over time, such as backlash between the sliding parts which can affect the silent and correct working, especially if the device has not been mounted perfectly.

A example of a device that attempts to overcome these problems is described in document EP1258586.

In this opening device, which can be used for single- and double-leaf doors, the rod activated by the elastic device is, in this case, formed of two parts joined together and the outermost end of the second part is connected by means of a swivel connection to a fixed member on the inner surface of the door. However, the disadvantage lies in the fact that the positioning of the gas spring and the dimensions of the two parts comprising the rod, are such as to render the device too unwieldy inside the piece of furniture, especially as regards the depth.

It was therefore found to be necessary to provide an innovative device for opening and retaining leaf doors capable of overcoming the above-mentioned problems.

### SUMMARY OF THE INVENTION

The primary aim of this invention is to provide an extremely compact device for opening and retaining leaf doors, hinged to the covering wall of a piece of furniture, suitable especially for use in pieces of furniture that are not very deep.

Another aim of the device of the invention is to ensure gentle and silent closing of the doors, and be reliable, ensuring correct working over time without inappropriate backlash as there are no sliding parts.

Yet another aim of the opening device of the invention is to ensure that it is functional while adjusting the position of the door with respect to the body of the piece of furniture.

This invention, therefore, proposes to achieve the objectives mentioned above by producing an opening device for leaf door suitable to be mounted on a piece of furniture, wherein said piece of furniture comprises said leaf door, a first wall and a second wall perpendicular to the first wall, said leaf door being at least perpendicular to said second wall and defining a respective rotation axis parallel to the first wall, wherein the opening device defines a respective open and closed positions, the open position corresponding to an open position of the leaf door and the closed position corresponding to a closed position of the leaf door with respect to the piece of furniture, and wherein said leaf door defines in its closed position a predetermined first angle with said first wall, the device comprising a first plate, suitable to be fixed to the second wall, comprising a first fixed pin, a first arm, having a first length, hinged by its first end to the first fixed pin and by its second end to a first mobile pin, a second arm, having a second length, hinged by its first end to the first arm by means of said first mobile pin and suitable to be fixed in rotation by its second end to the leaf door by means of a fixed second pin, characterized by the fact that a second angle formed between the first and second arms on their side facing the leaf door is greater than 0° when the leaf door is in its closed position and smaller than 180° when the leaf door is in its open position by an angle up to a predetermined value from its closed position.

Advantageously, this predetermined angle is within the range of 0÷30°.

The rod or lever, possibly activated by means of an elastic member such as a gas spring, is connected to the door by means of an intermediate oscillating member distinctly shorter than the rod. This intermediate member is hinged on one side to the free end of the rod and on the other end to fixing means, fixed rigidly on the inner surface of the door.

Advantageously, the intermediate oscillating member is sized in such a manner that, when the door is in the open position, the sum of a first distance between the rod articulation axes and a second distance between the intermediate oscillating member articulation axes is slightly greater than a third distance between the rod articulation axis on the piece of furniture and the intermediate member articulation axis on the door; while the difference of said first and second distances is slightly less than the third distance when the door is in the closed position. Thanks to such sizing of the components, the intermediate oscillating member constitutes the extension of the rod in the open position, while it is folded up in the closed position, reducing the dimensions of the device of the invention to the minimum.

The length of the gas spring or another elastic means, in its retracted configuration may be greater or lesser than the rod length, while it is always greater than the length of the intermediate oscillating member.

Advantageously, the angle formed between the rod and intermediate member, on the side facing the door, is slightly more than 0° in the closed position and slightly less than 180° in the position when opened to such a width that the door can oscillate without sticking. Said angle between rod and intermediate member is within the range of 10-30° in the door closed position, while in the open position, it is in the range of 150-170°.

Another advantage lies in the fact that there are no sliding parts, thereby making the device of the invention less weak, since it is free of backlash and therefore more reliable. Use of a known type of decelerator also makes it possible to shut the door of the piece of furniture gently.

For optimum adjustment of the door position with respect to the piece of furniture body, the pivot pin of the intermediate oscillating member on the door is housed on the fixing means of said intermediate member, said fixing means being advantageously adjustable with respect to the door at least vertically, considering a configuration with leaf door shut as shown in FIG. 4. Preferably, the fixing means bearing the pivot pin include a mount base for a known type of hinge. In a preferred variation, the mount base is provided with a longitudinal intermediate plate that can be moved by means of a cam and fixed in the desired position. This plate can be advantageously provided with release coupling devices to make it easier to fix an additional plate, suitably provided and connected to the intermediate oscillating member.

Thanks to said at least vertical adjustment, made possible by the mount base, possible variations in the device setup and thereby the torque provided by the elastic medium can be compensated, for example, when the position of the hinges connecting the door to the piece of furniture is adjusted in relation to the door or parts of the adjacent piece of furniture. The correct setup of the device also ensures correct working of the decelerator.

Advantageously, the hinges connecting the door to the piece of furniture are separate from the opening device. These hinges, normally used for doors with vertical axis, allow adjustment along the three Cartesian axes. In particular, lateral adjustment with respect to the door with vertical axis makes it possible, in case of leaves, to adjust them vertically and can influence the opening device setup especially in the closing position in such a manner as to modify/optimize the torque provided by the gas spring or another suitable elastic device.

The dependent claims describe the preferred embodiments of the invention.

### BRIEF DESCRIPTION OF THE FIGURES

Other characteristics and advantages of the invention will become apparent in the light of a detailed description of a preferred, but not exclusive embodiment of a device for opening a rotating leaf door illustrated by way of non-limitative example, with the help of the following drawings.

FIG. 1 shows a side view of the device of the invention in the open position;

FIG. 2 shows a side view of a first component of the device in FIG. 1;

FIG. 3 shows a cross section of a second component of the device in FIG. 1;

FIG. 4 shows a side view of the device of FIG. 1 in the closed position;

FIG. 5 shows a side view of a third component of the device of FIG. 1;

FIG. 6 shows a side view of a fourth component of the device of FIG. 1;

FIGS. 7 and 8 show side views of the device according to the invention with door position adjusted upwards and downwards, respectively;

FIG. 9 shows a cross section of a fifth component of the device of the invention;

FIG. 10 shows a cross section of a sixth component of the device of the invention.

### DETAILED DESCRIPTION OF A PREFERRED EMBODIMENT OF THE INVENTION

With reference to the Figures, a representation of a device for opening and retaining leaf doors is given below, comprising:
possible elastic means 10, such as for example, a gas spring or a simple helical spring,
a rod or lever 8,
fixing means 21 for fixing said lever 8 to leaf door 1,
an intermediate oscillating member 19 connecting said lever 8 to fixing means 21.

A leaf door 1 is connected to a covering wall 2 of a piece of furniture by means of a hinge 3, for example, of the articulated quadrilateral type, with the possibility of adjustment along the three Cartesian axes. A support or plate 5 provided with a hinge pin or fulcrum 7 for the lever 8 of the device and a pin or fulcrum 9 for fixing one end of gas spring 10 are connected to the side wall 4 of the piece of furniture, by means of screws 6. The other end of the gas spring 10 is hinged to a pin 11 which forms an integral part of the lever 8.

Advantageously, to ensure minimum encumbrance of the device inside the piece of furniture, the pins or fulcra 7, 9 are fitted in the space between door 1 in the closed position and a flat surface including X, the pivoting direction of the door, as well as the bisector of the angle between covering wall 2 and door 1 in the closed position.

The position and layout of the holes for fixing support 5 to side wall 4 is such as to allow interchangeability with other similar supports, suitable for fixing different opening devices, for example, suitable for double-leaf doors.

The lever 8, near the joining area of support 5 with pin 7, has a bracket-like projection 12, forming a right angle with the lever body. In the door closed position, this projection 12 presses a projecting stem 13 of a known type of deceleration device 14, preferably comprising a cylinder-piston system filled with fluid that is compelled to flow through a throttle valve to obtain a braking effect. This deceleration device 14, an example of which is illustrated in FIG. 5, placed under pressure inside a projecting cylindrical part 15 near a support corner 5, slows down the leaf closure movement when stem 13 is pushed by projection 12 of lever 8, while allowing free opening movement in the opposite direction.

Gas spring 10, in the leaf closed position, in turn, exerts a push which creates a moment that acts on the lever in the closing direction. During the opening, after overcoming a dead centre, the gas spring, on the other hand, creates a moment which pushes lever 8 to open the leaf completely open and hold it in this position.

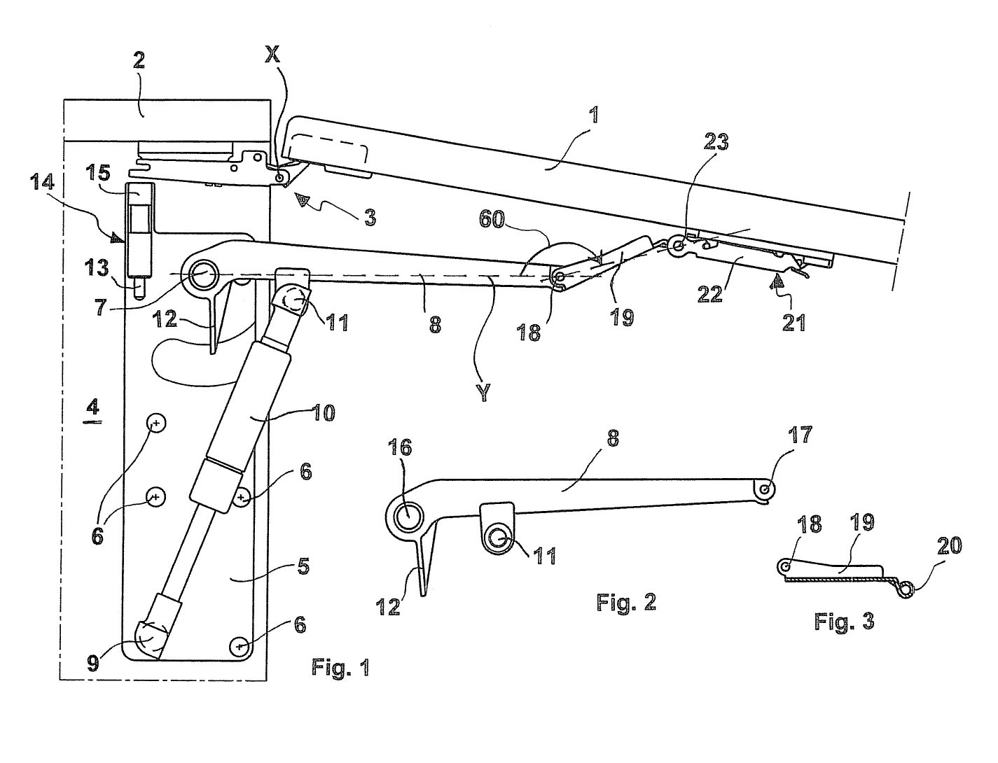

Lever 8, illustrated in FIG. 2, has at its ends, pivot holes 16, 17 by means of which it is connected in swivel mode to pivot pin 7 of support 5 and pivot pin 18 of oscillating member 19, respectively. Said oscillating member 19 is, in turn, connected at its other end by means of articulation 20 to the fixing means on the door, fixed on the inner surface of door 1.

Said fixing means preferably include a mount 21 used for fixing hinges to the sides of a piece of furniture, on which a mount plate 22 is fitted, provided with pivot pin 23 for oscillating member 19.

From FIG. 1 it is clear that in the door open position, the sum of the distances between pivot pins 7 and 18 and between pins 18 and 23 is slightly greater than the distance between pivot pins 7 and 23, and that lever 8 and intermediate oscillating member 19 form a positive angle slightly less than 180°, on the side facing door 1, advantageously between 150 and 170°.

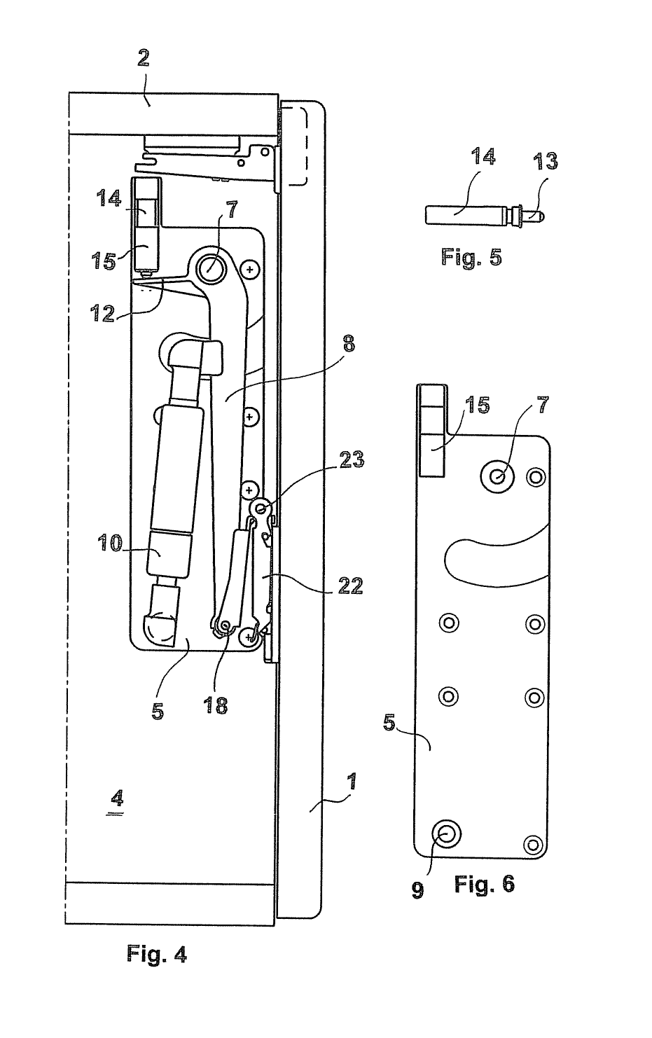

From FIG. 4, on the other hand, it is clear that the difference between the distances between pins 7 and 18 and between pins 18 and 23 is slightly less than the distance between pins 7 and 23, and that lever 8 and oscillating member 19 form a positive acute angle slightly greater than 0°, advantageously between 10 and 30°. Considering the short dashed line Y in FIG. 1, curved arrow 60 indicates the increasing direction of the positive angle between the lever 8 and the oscillating member 19.

Advantageously in the leaf door closed position, illustrated in FIG. 4, when the opening device is mounted on the piece of furniture, the distance of the pivot pin 18 from the door 1 is greater than the distance of the pivot pin 23 from said door and smaller than the distance of the pivot pin 7 with respect to the same door. This configuration confers to the system an high compactness, by occupying a very restrained space towards inside of the piece of furniture and avoiding possible jams. This fact is further underlined by the substantially vertical arrangement of the gas spring 10, placed inside the piece of furniture with respect to the opening or oscillation device in a position substantially parallel to the lever 8.

Advantageously, the plate 22, comprising the pivot pin 23, is housed on mount 21 so door 1 can be adjusted at least vertically in the closed position.

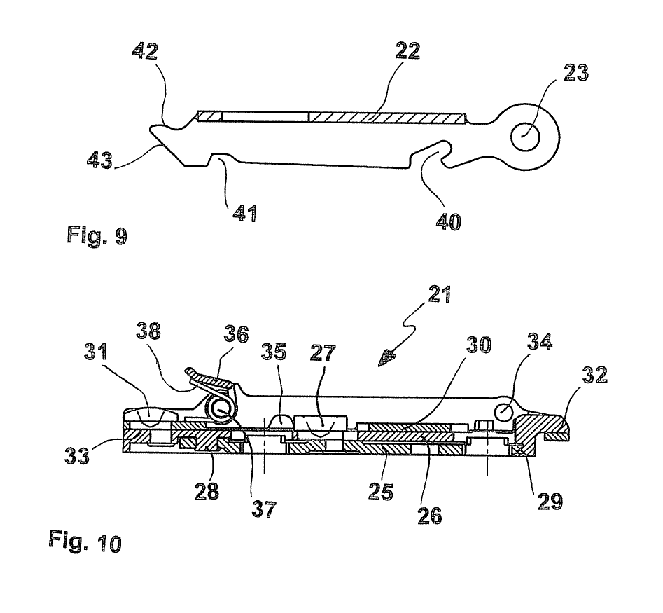

In the examples illustrated in FIGS. 9 and 10, the mount 21 is advantageously made up of:
a sub-base 25, that can be fixed by means of screws (not shown in the Figure) to door 1,
a base plate 26 that moves on sub-base 25, by rotation of cam 27, along guides 28 and 29 transversely perpendicular to the Figures sheet,
and an upper plate 30 that can be moved on support plate 26, by rotation of cam 31, along guides 32 and 33 in a longitudinal direction corresponding to the vertical direction of door 1 in the closed position.

The upper plate 30 is provided with front pins 34 which project sideways, lateral truncated-conical stops 35 and a rear hooking tooth 36 oscillating around pin 37 and activated by spring 38. Plate 22, connected to intermediate oscillating member 19, has corresponding openings or cavities 40 and 41 for hooking to front pins 34 and side stops 35, respectively, so that these can be hooked in front, by inserting the cavity 40 on pins 34, and rotated backwards so that openings 41 fit around side stops 35 and hooking tooth 36 fits into the rear projections 42 from the top, after being moved backwards from the inclined flat surface 43. This configuration of the fixing means allows easy coupling of plate 22 to mount 21. However, more economical, less elaborate means such as screw fittings can be used for fixing to the door, as long as adjustment is possible.

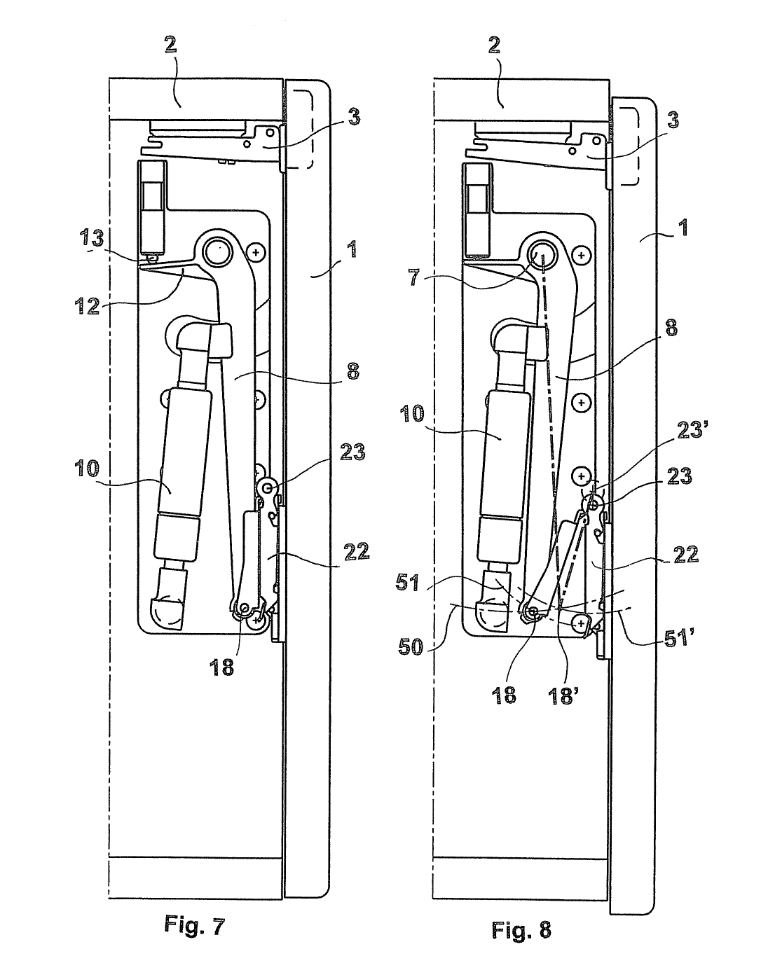

FIGS. 7 and 8 highlight the effect that adjustment of the door position with respect to the piece of furniture upwards and downwards has on the invention device set up. This adjustment is obtained by means of hinges 3 which make it possible to change the position of the door rotation axes X with respect to the piece of furniture covering wall 2.

A comparison shows how adjustment of the door upwards brings rod or lever 8 in the closed position closer to door 1, so that gas spring 10 exerts a lower torque and deceleration device 14 stem 13 is compressed to a lesser extent.

Adjustment of the door 1 downwards, on the other hand, moves rod 8 farther away from door 1, stem 13 is compressed completely and the gas spring exerts a higher torque. The short dashed lines in FIG. 8 show how the device can be realigned by adjusting plate 22 upwards, so that pivot pin 23 shifts in the position 23′ and pivot pin 18 moves to position 18′ corresponding to the device position shown in FIG. 4. Position 18′ is identified by the intersection of arches 50, 51′, defined by oscillation of lever 8 with respect to pivot pin 7 and oscillation of pin 18 with respect to pivot position 23′, respectively. Arch 51 is defined by oscillation of pin 18 with respect to pivot pin 23.

1-14. (canceled)

15. Opening device for leaf door suitable to be mounted on a piece of furniture, wherein said piece of furniture comprises said leaf door, a first wall and a second wall perpendicular to the first wall, said leaf door being at least perpendicular to said second wall and defining a respective rotation axis parallel to the first wall,
wherein the opening device defines a respective open and closed positions, the open position corresponding to an open position of the leaf door and the closed position corresponding to a closed position of the leaf door with respect to the piece of furniture,
and wherein said leaf door defines in its closed position a predetermined first angle with said first wall, the opening device comprising
a first plate, suitable to be fixed to the second wall, comprising a first fixed pin,
a first arm, having a first length, hinged by its first end to the first fixed pin and by its second end to a first mobile pin, and being provided with a projection near the first fixed pin suitable to activate said deceleration means during a closing movement,
a second arm, having a second length, hinged by its first end to the first arm by means of said first mobile pin and suitable to be fixed in rotation by its second end to the leaf door by means of a second fixed pin,
a second angle formed between the first and second arms on their side facing the leaf door being greater than 0° in the leaf door closed position and smaller than 180° when the leaf door is in its open position by an angle up to a predetermined value from its closed position,
first adjustment means for adjusting the position of the second fixed pin with respect to the leaf door at least in one direction,
said first adjustment means comprising a mount plate and a second plate to which the second fixed pin is fixed,
said mount plate comprising cams and release coupling means for hooking the second plate to the mount plate.

16. Device according to claim 15, wherein said predetermined value is between 0° and 30°.

17. Device according to claim 15, wherein in said leaf door closed position, when mounted on the piece of furniture, the distance of the first mobile pin from the leaf door is greater than the distance of the second fixed pin from said leaf door and smaller than the distance of the first fixed pin from the same leaf door.

18. Device according to claim 17, comprising an elastic means, having a third length in its retracted configuration, hinged by its first end to a fixed third pin provided on the first plate and by its second end to a mobile second pin fixed on the first arm between the first fixed pin and the first mobile pin so as to act on said first arm during leaf door opening/closing.

19. Device according to claim 18, wherein said first and third fixed pins are located in a space between a flat surface, comprising rotation axis and bisector of said predefined first angle, and the leaf door in the closed position.

20. Device according to claim 15, wherein the second length is much shorter than the first length.

21. Device according to claim 18, wherein leaf door deceleration means are provided on said first plate.

22. Device according to claim 21, wherein said deceleration means include a cylinder-piston system.

23. Piece of furniture comprising a door suitable to be opened and the opening device according to claim 15, wherein there are provided second adjustment means for adjusting the position of the rotation axis with respect to the first wall.

24. Piece of furniture according to claim 23, wherein said second adjustment means are hinges.
